(19) United States
(12) Patent Application Publication
(10) Pub. No.: US 2025/0346308 A1
(43) Pub. Date: Nov. 13, 2025

(54) REAR AERODYNAMIC SKIRT FOR SEMI-TRAILER AND ALIKE

(71) Applicant: TRANSTEX INC., Saint-Laurent (CA)

(72) Inventors: Mathieu BOIVIN, Mont-Royal (CA); Pierre-Yves LACROIX, Laval (CA); Jacques LECLERC, Pierrefonds (CA); Robin GAUDREAU, Saint-Colomban (CA); Steven PACHECO, Montreal (CA)

(21) Appl. No.: 18/867,997

(22) PCT Filed: Jun. 3, 2023
(86) PCT No.: PCT/CA2023/050762

§ 371 Date: Nov. 21, 2024

Related U.S. Application Data
(60) Provisional application No. 63/348,909, filed on Jun. 3, 2022.

(51) Int. Cl. B62D 35/02; B62D 35/00

(52) U.S. Cl. CPC B62D 35/02; B62D 35/001

(57) ABSTRACT

A rear aerodynamic skirt assembly is configured to be mounted to a semi-trailer rear to the semi-trailer axle(s) and front of the rear underride guard. The rear aerodynamic skirt assembly comprises a sheet of material and securing mechanisms. The shape of the sheet of material and the nature of the securing mechanism used to mount the sheet of material to the semi-trailer provide the desired air-deflecting function while providing the resilience necessary to resist to risks associated with being mounted to a vehicle, e.g., a semi-trailer.

### CROSS-REFERENCE TO RELATED APPLICATION

This application claims priority under 35 U.S.C. § 119 (e) from U.S. provisional patent application 63/348,909 filed Jun. 3, 2022, entitled REAR AERODYNAMIC SKIRT FOR SEMI-TRAILER AND ALIKE the specification of which is hereby incorporated herein by reference in its entirety.

### BACKGROUND

### (a) Field

This invention generally relates to an aerodynamic skirt and an assembly comprising a strut and an aerodynamic skirt. More precisely, the invention relates to a rear aerodynamic skirt and related assembly, configured to be mounted to a vehicle, e.g., a semi-trailer, to improve the aerodynamic efficiency of the vehicle.

### (b) Related Prior Art

Road tractors are used to pull semi-trailers on roads to transport cargo. Aerodynamic apparatuses are installed on the road tractor and/or on the semi-trailer in order to reduce the aerodynamic air drag and improve fuel efficiency.

It is known to install trailer skirts made of rigid materials on both lateral sides of a road semi-trailer frontward to the axles to help manage the flow of air around and underneath the semi-trailer. These aerodynamic skirts are secured to the bottom portion of the semi-trailer, or to the sides of the semi-trailer's floor, to ensure proper positioning when the vehicle is moving.

People who are familiar with the trucking industry know that semi-trailers are built in various configurations. Frame assembly of semi-trailers can use members and beams of different dimensions. For example, a beam that is commonly used in semi-trailer manufacturing in North America is a I-beam. Alternatively, there may be usage of H-beam, W-beam (for “wide flange”), Universal Beam (UB), Rolled Steel Joist (RSJ), or double-T, a beam with an I or H-shaped cross-section. The horizontal elements of the “I” are known as flanges, while the vertical element is termed the “web”. I-beams are usually made of structural steel, or aluminum, and are used in construction and civil engineering. The web resists most of the shear forces, while the flanges resist most of the bending moment experienced by the beam. Beam theory shows that the I-shaped section is a very efficient form for carrying both bending and shear loads in the plane of the web. An adaptable securing mechanism is hence desirable to adapt to a range of I-beam dimensions.

The skirts, because of their position under the semi-trailer's floor and their proximity to the road, are significantly vulnerable and might easily enter in contact with surrounding obstacles. Portions of the securing mechanism holding the skirts, when put under significant stress, can plastically bend and/or break to affect the skirts' position in respect to the road semi-trailer thus reducing the efficiency of the skirts. Additionally, the assembly can be crooked or not precisely aligned, which causes additional challenges to secure the aerodynamic skirt assembly to the vehicle.

Aerodynamic skirt assemblies in the art are complex to install given the many adjustments required to match the precise configuration of each semi-trailer. The number of parts required to secure the strut to the semi-trailer is generally significant and time-consuming to assemble. Also, the weight of the skirt assembly is important to prevent unduly adding weight to the semi-trailer and hence increase its fuel consumption.

The struts need to be rigid enough to remain in their operating position and efficiently channel airflow around the semi-trailer. This required rigidity is significant and is detrimental to proper flexing of the skirt assembly when contacting a foreign object.

Such techniques and challenges have been contemplated in relation to front-axle skirts. However, challenges remain in relation to axle rear skirts, related to dimensions, locations, positioning, etc., with variable configurations of semi-trailers.

Therefore, there exists a need in the art for an improved rear aerodynamic skirt and a rear aerodynamic skirt assembly over the existing art.

### SUMMARY OF THE INVENTION

It is one aspect of the present invention to alleviate one or more of the drawbacks of the background art by addressing one or more of the existing needs in the art.

Accordingly, embodiments of this invention provide an improved semi-trailer rear aerodynamic skirt assembly over the prior art.

In some aspects, the techniques described herein relate to a vehicle including an underfloor, a rear axle, and a pair of rear aerodynamic skirt assemblies mounted on each side to the vehicle, each of the rear aerodynamic skirt assemblies including: A skirt panel including a mounting face and a planar air-deflecting face; a resilient first securing mechanism, the securing mechanism being secured to the underfloor of the vehicle rear to the rear axle with a low-front portion of the mounting face of the skirt panel mounted thereto; and a second securing mechanism designed to be deformable, the second securing mechanism being used to mount at least a rear portion of the skirt panel to the vehicle.

In some aspects, the techniques described herein relate to a vehicle, wherein the first securing mechanism is designed to resiliently buckle when undergoing a center-ward external force over a threshold value.

In some aspects, the techniques described herein relate to a vehicle, wherein the first securing mechanism is designed to resiliently buckle when undergoing an outward external force over a threshold value.

In some aspects, the techniques described herein relate to a vehicle, wherein the skirt panel is made of a sheet of material that has a generally uniform thickness.

In some aspects, the techniques described herein relate to a vehicle, wherein a top-front portion of the mounting face of the skirt panel is mounted to the first securing mechanism, with a portion of the skirt panel attachment-free between the low-front portion and the top-front portion.

In some aspects, the techniques described herein relate to a vehicle, further including a centerline, wherein the skirt panel has a top edge and a bottom edge, wherein the skirt panel is mounted parallel to the centerline with the top edge and the bottom edge at the same distance to the centerline.

In some aspects, the techniques described herein relate to a vehicle, further includes side walls, and wherein the skirt panel is mounted flush to the side walls.

In some aspects, the techniques described herein relate to a vehicle, further including a rear underride guard, wherein the skirt panel is mounted front to the rear underride guard.

In some aspects, the techniques described herein relate to a vehicle, wherein the skirt panel includes a rear edge, and wherein the skirt panel is mounted with the rear edge distant to the rear underride guard.

In some aspects, the techniques described herein relate to a vehicle, wherein the planar air-deflecting face extends in a plane outward to an outer extremity of the rear underride guard.

In some aspects, the techniques described herein relate to a vehicle, wherein the second securing mechanism is secured to the rear underride guard.

In some aspects, the techniques described herein relate to a vehicle, wherein the first securing mechanism and the second securing mechanism are not identical.

In some aspects, the techniques described herein relate to a vehicle, wherein each of the skirt panels has a front edge and a rear edge, and wherein the rear edge is shorter than the front edge.

In some aspects, the techniques described herein relate to a vehicle, further including side walls, wherein each of the skirt panels has a top edge and wherein the top edge of each of the skirt panels adjoins one of the side walls.

In some aspects, the techniques described herein relate to two rear aerodynamic skirt assemblies configured to be mounted to a vehicle on each side, the vehicle having an underfloor and a rear axle, each of the rear aerodynamic skirt assemblies including: a skirt panel including a mounting face and a planar air-deflecting face; a resilient first securing mechanism including: an underfloor mounting means to be secured to the underfloor of the vehicle rear to the rear axle; and a skirt securing face to mount a low-front portion of the mounting face of the skirt panel thereto; and a second securing mechanism designed to be deformable, the second securing mechanism being designed to mount at least a rear portion of the skirt panel to the vehicle.

In some aspects, the techniques described herein relate to rear aerodynamic skirt assemblies, wherein the first securing mechanism is designed to resiliently buckle when undergoing a center-ward external force over a threshold value.

In some aspects, the techniques described herein relate to rear aerodynamic skirt assemblies, wherein the first securing mechanism is designed to resiliently buckle when undergoing an outward external force over a threshold value.

In some aspects, the techniques described herein relate to a rear aerodynamic skirt assemblies, wherein the skirt panel is made of a sheet of material that has a generally uniform thickness.

In some aspects, the techniques described herein relate to a rear aerodynamic skirt assemblies, wherein the first securing mechanism includes a top sheet securing face to mount a top-front portion of the mounting face of the skirt panel thereto, with a portion of the skirt panel attachment-free between the low-front portion and the top-front portion.

### BRIEF DESCRIPTION OF THE DRAWINGS

Further features and advantages of the present disclosure will become apparent from the following detailed description, taken in combination with the appended drawings, in which:

FIG. 1 is a perspective view of a semi-trailer with a rear aerodynamic skirt assembly mounted thereto in accordance with an embodiment;

FIG. 2 is a side elevation view of a semi-trailer with a rear aerodynamic skirt assembly mounted thereto at a first location in accordance with an embodiment;

FIG. 3 is a side elevation view of a semi-trailer with a rear aerodynamic skirt assembly mounted thereto at a second location in accordance with an embodiment;

FIG. 4 is a side elevation view of a semi-trailer with a rear aerodynamic skirt assembly mounted thereto in accordance with another embodiment;

FIG. 5 is a perspective exploded view of a rear aerodynamic skirt assembly in accordance with a first embodiment;

FIG. 6 is a perspective exploded view of a rear aerodynamic skirt assembly in accordance with a second embodiment;

FIG. 7 is a bottom-side partial view of a semi-trailer with rear aerodynamic skirt assemblies mounted thereto in a first position in accordance with a first embodiment;

FIG. 8 is a bottom view of a portion of the semi-trailer and one of the rear aerodynamic skirt assemblies of FIG. 7 in the first position;

FIG. 9 is a bottom-side partial view of the semi-trailer with rear aerodynamic skirt assemblies mounted thereto of FIG. 7 in a second position;

FIG. 10 is a bottom view of a portion of the semi-trailer and one of the rear aerodynamic skirt assemblies of FIG. 9 in the second position;

FIG. 11 is a side view of the portion of a securing mechanism configured to have a rear skirt panel mounted thereto in accordance with an embodiment;

FIG. 12 is a partial side view of the semi-trailer of FIG. 1 with a narrow rear skirt panel;

FIGS. 13 and 14 are partial side views of the semi-trailer of FIG. 1 with a tapered rear skirt panel of respectively a first longitudinal length, and of a second longitudinal length;

FIGS. 15 to 18 are partial upward perspective views of the semi-trailer of FIG. 1 with curved rear skirt panels mounted thereto;

FIGS. 19A and 19B are respectively a schema of total air pressure coefficient around the semi-trailer of FIG. 1 as estimated by fluid dynamic modelip6162 ng without the rear skirt panels mounted thereto and a schema of total air pressure coefficient around the semi-trailer of FIG. 1 with the rear skirt panels mounted thereto when the semi-trailer is moving at about 104 km/h at 4.5-degree yaw angle, wherein the schemas are measures along a vertical plane along the centerline of the semi-trailer;

FIGS. 20A and 20B are respectively a partial perspective view of a semi-trailer with a rear skirt panel mounted thereto and an exploded view of the rear skirt panel with the mounting components used to mount the skirt panel to the semi-trailer in accordance with an embodiment;

FIGS. 21A and 21B are respectively a partial perspective view of a semi-trailer with a rear skirt panel mounted thereto and an exploded view of the rear skirt panel with the mounting components used to mount the skirt panel to the semi-trailer in accordance with another embodiment;

FIGS. 22A and 22B are respectively a partial perspective view of a semi-trailer with a rear skirt panel mounted thereto and an exploded view of the rear skirt panel with the mounting components used to mount the skirt panel to the semi-trailer in accordance with another embodiment;

FIGS. 23A and 23B are respectively a partial perspective view of a semi-trailer with a rear skirt panel mounted thereto and an exploded view of the rear skirt panel with the mounting components used to mount the skirt panel to the semi-trailer in accordance with another embodiment; and

FIGS. 24A and 24B are respectively a partial perspective view of a semi-trailer with a rear skirt panel mounted thereto and an exploded view of the rear skirt panel with the mounting components used to mount the skirt panel to the semi-trailer in accordance with another embodiment.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as”, or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as “first”, “second”, “top”, “bottom”, “above”, “below”, and the like, are words of convenience and are not to be construed as limiting terms.

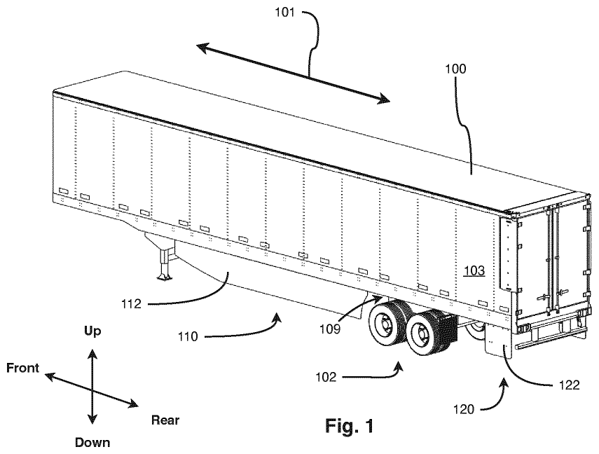

The terms “top”, “up”, “upper”, “bottom”, “lower”, “down”, “vertical”, “horizontal”, “interior” and “exterior” and the like are intended to be construed in their normal meaning in relation with normal installation of the product, with an indication of the normal orientation of the rear aerodynamic skirt mounted to a semi-trailer being provided on FIG. 1.

It should further be noted that for purposes of this disclosure, the term “coupled” means the joining of two members directly or indirectly to one another. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It should further be noted that for purposes of this disclosure, the use of the term “semi-trailer” is intended for exemplary purpose only. The described innovation may apply to a range of ground engaging auto-propelled vehicle such as tractors and box trucks, and ground-engaging hauled vehicle such as trailers, semi-trailers, container chassis, etc.

Referring now to the drawings, and more particularly to FIG. 1, a semi-trailer 100 is equipped with a pair of front skirt assemblies 110, installed in front of the semi-trailer axle(s) 102 on each side of the semi-trailer 100 generally along a longitudinal axis 101. The front skirt assemblies 110 are adapted to deflect and direct the airflow around the semi-trailer 100. Each of the front skirt assemblies 110 includes a front skirt panel 112 adapted to be disposed on the side of the semi-trailer 100, and a plurality of securing mechanisms (not shown) adapted to secure the front-axle skirt panel 112 to the semi-trailer 100. Once installed on the semi-trailer 100, the front skirt assembly 110 prevents high-energy flow from hitting the bogie and drivetrain components of the axles 102 to reduce the air drag of the vehicle when the semi-trailer 100 moves on the road, pulled by the road tractor.

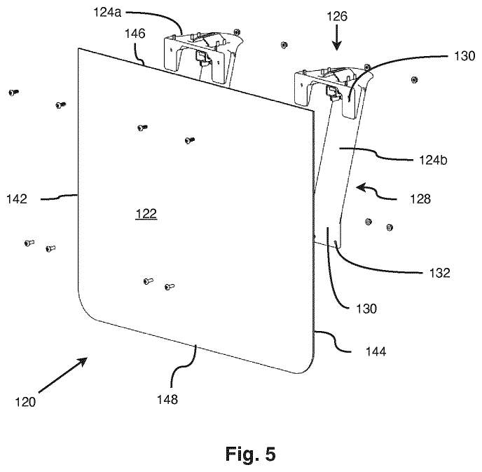

Similarly, the semi-trailer 100 is equipped with a pair of rear skirt assemblies 120, installed rearward to the semi-trailer axle(s) 102 on each side of the semi-trailer 100 generally along a longitudinal axis 101. The rear skirt assemblies 120 are adapted to deflect and direct the airflow flowing toward the rear of the semi-trailer 100. Each one of the rear aerodynamic skirt assemblies 120 includes a rear skirt panel 122 adapted to be disposed on the side of the semi-trailer 100 rear to the semi-trailer axle(s) 102, and a plurality of securing mechanisms 124 (e.g., see FIG. 5) adapted to secure the rear skirt panel 122 to the semi-trailer 100. Once installed on the semi-trailer 100, the rear skirt assembly 120 influence the airflow rearward to the axle(s) 102 of the semi-trailer 100, influencing the air pressure over the rear surface 108 of the semi-trailer 100, usually the rear doors. Practically, the effect of the modified airflow resulting from the rear skirt assemblies 120 is observed to have a chain reaction that sums up to a substantial increase of the air pressure rearward to the rear surface 108 of semi-trailer 100 particularly close to its top that reduces the air drag of the vehicle when the semi-trailer 100 moves on the road, pulled by the road tractor.

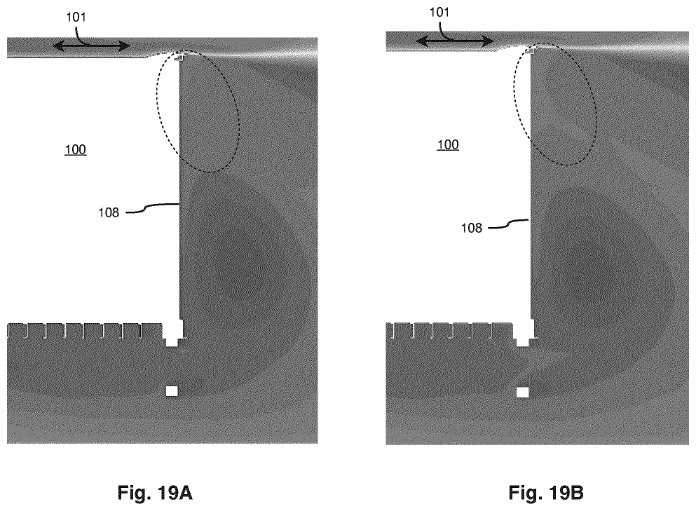

For illustration, FIGS. 19A-B depict the changes in the total air pressure rearward to the rear surface 108 of the semi-trailer 100 about its centerline 105. Particularly, FIG. 19B compared to FIG. 19A demonstrated that the presence of the rear skirt assemblies 120 on a semi-trailed being hauled at about 104 km/h at 4.5-degree yaw angle results in the air pressure rearward to the rear surface about the top of the semi-trailer 100 getting closer in value to the atmospheric pressure over a substantial area, decreasing substantially the drag effect over the rear surface 108 of the semi-trailer 100.

It is worth noting that tests demonstrated that the efficacy of the rear skirt assemblies 120 is greatly dependent to the presence of front skirt assemblies 110. Rear skirt assemblies 120 without front skirt assemblies 110 results in a drag reduction substantially lower than in combination. Thus, tests demonstrated that the front skirt assemblies 110 and the rear skirt assemblies 120 provides a synergy that improve the efficacy of both toward drag reduction over the semi-trailer 100. Furthermore, is a top deflector is mounted about the rear edge of the roof of the semi-trailer 100, efficacy if furthermore improved. As a result less drag force applies to the semi-trailer 100.

One can appreciate from FIG. 1 that the semi-trailer 100 may include slider rail (not shown) used to adjust the location of the axle(s) 102 on the semi-trailer 100, thus providing potential interference with the rear skirt assemblies 120 and modifying the operating conditions of the semi-trailer 100, including the rear skirt assemblies 120.

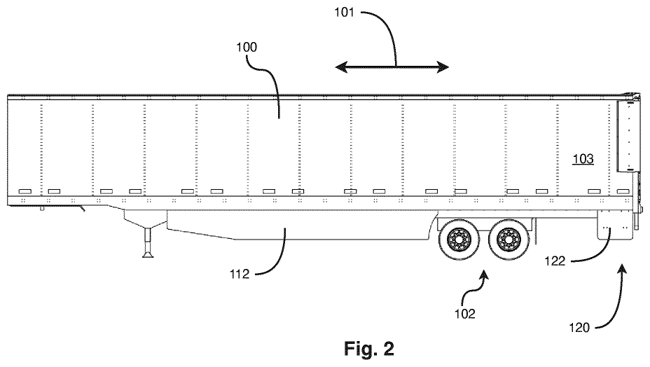

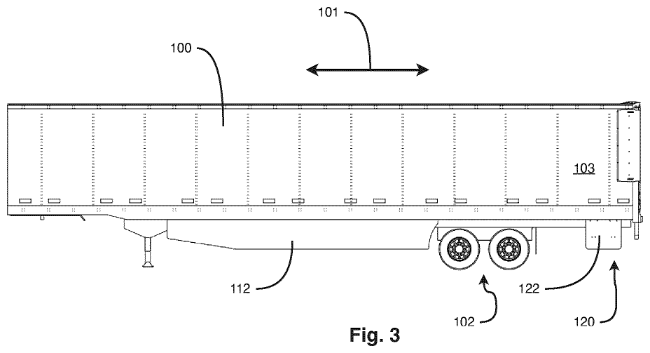

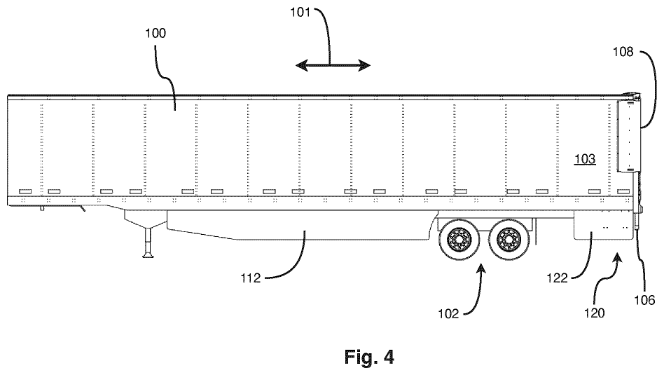

Referring additionally to FIGS. 2 to 4, based on the operating location of the axle(s) 102, the location (when not movable) of the axle(s) 102, and other parameters (such as the distance between the axles and the rear of the semi-trailer 100, the presence of complementary aerodynamic components, the configuration of the complementary aerodynamic components, etc.), operating parameters may vary, comprising at least one of
a) most efficient location of the rear skirt panel 122 (more or less rearward relative to the axle(s) 102);
b) most efficient dimension of the rear skirt panel 122 (longer or shorter longitudinal dimension, the skirt panel 122 extending farther or closer to the ground, etc.); and
c) most efficient operating angle and shape of the rear skirt panel 122 (relative to the longitudinal axis 101 of the semi-trailer 100).

It is therefore contemplated that the same rear skirt assemblies 120 may be configured to adopt many different configurations to respond to at least the most efficient location and most efficient operating angle. Other parameters like the location of the semi-trailer's wheels, the size of the wheels, the length of the semi-trailer and the distance between the ground and the semi-trailer's floor can also be material in the desired configuration.

It is further contemplated that the rear skirt assemblies 120 should be able to undergo minor changes to respond to the most efficient dimension parameter.

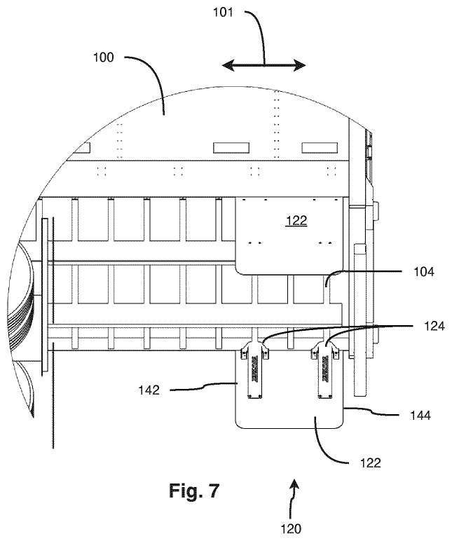

Referring now to FIG. 1 and FIGS. 5-6, each one of the rear skirt assemblies 120 comprises at least two securing mechanisms 124a or 124b configured to be mounted to the underfloor of the semi-trailer 100, and according to an embodiment to the I-beams 104 (see FIG. 7) transversal to the longitudinal axis 101 of the semi-trailer 100.

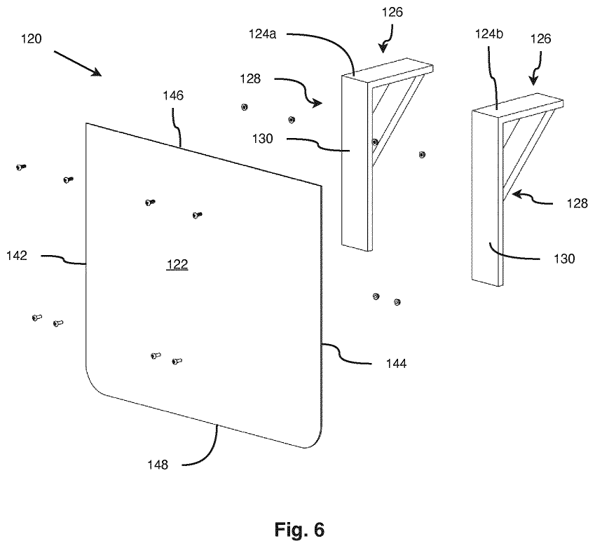

The securing mechanism 124 includes a connector portion 126 and a strut portion 128. The strut portion 128 includes a securing face 130, continuous or not, for securing the rear skirt panel 122 thereto. In the illustrated embodiments, the securing face 130 comprises holes 132 (depicted on FIG. 5, not depicted on FIG. 6) for securing the lower portion and the upper portion of the skirt panel 122 with fasteners or rivets, for example. When the securing face 130 is interrupted, the planar sections defining the securing face 130 are preferably aligned along a unique plane for efficiently adjoining the rear skirt panel 122.

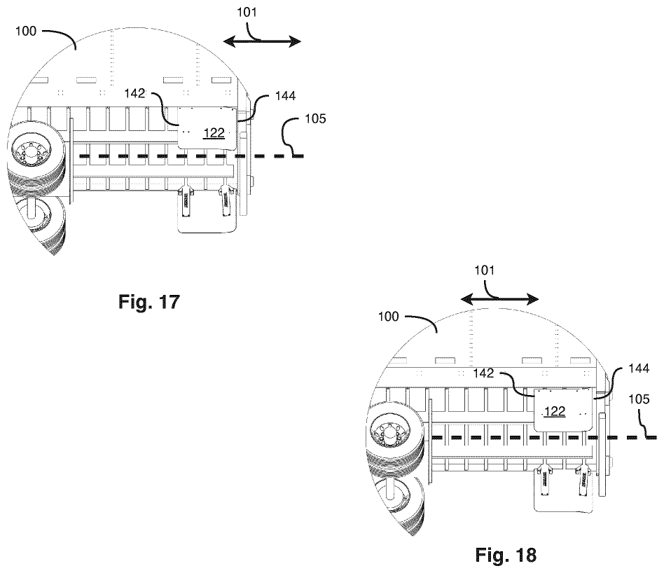

According to an embodiment, the unique plane is vertical. According to another embodiment, the unique plane has an angle relative to the vertical, e.g., of between about 1 and 10 degrees relative to the vertical with its bottom being closer to the centerline 105 (see FIG. 15-18) than its top.

The connector portion 126 for its part is mounted to the underfloor of the semi-trailer preferably using a clamping solution over the I-beams 104, or alternately using more common fastening solutions such as screws or bolts.

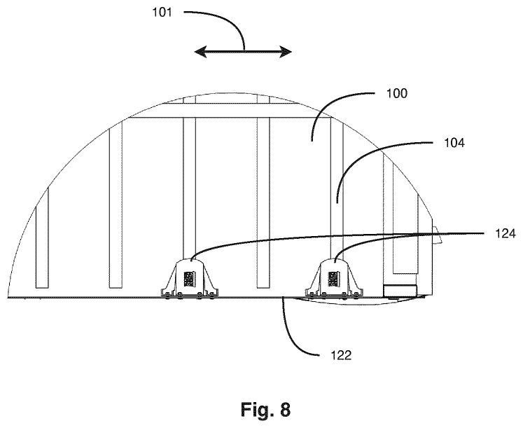

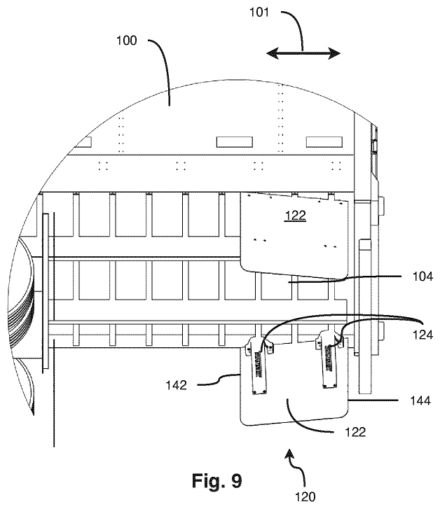

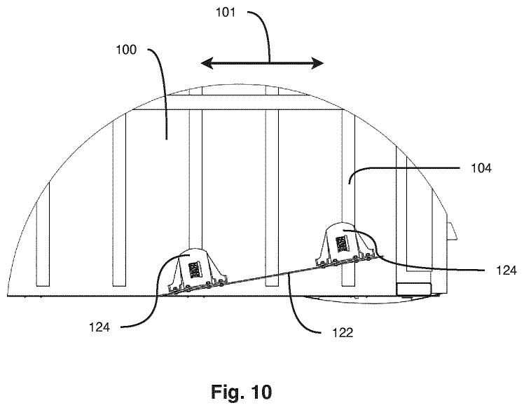

Referring to FIG. 1 and FIGS. 7-10, the rear skirt assemblies 120 is configured to be mounted to adapt to the restrictions associated with the semi-trailer 100. According to a realization depicted on FIGS. 7 to 10, the rear skirt assemblies 120 is adapted to be mounted to the semi-trailer 100 (between the ground level and up to the underfloor level) either parallel to the longitudinal axis 101 or at an angle relative to the longitudinal axis 101. When mounted at an angle (greater than 0) relative to the longitudinal axis 101, the rear skirt panels 122 are configured with the greater distance between their front edges 142 than their rear edges 144, deflecting the turbulent airflow resulting from the rotation of the wheels toward the centerline 105 of the semi-trailer 100.

According to a first realization, the rear skirt assemblies 120 comprises a single rear skirt panel 122 per side. The rear skirt panel 122 is sized to extend over at least 30 cm, and preferably at least 60 cm over the length between the rearmost axle of the semi-trailer 100 and the rear underride guard 106, aka RUG 106 (see FIG. 1) of the semi-trailer 100.

The rear skirt panel 122 is mounted at a distance of at least 30 cm from the rearmost axle and at least 30 cm from the RUG 106. Analysis of the efficacy of the rear skirt panel 122 demonstrated that extending the rear skirt panel 122 closer to the RUG 106 does not significantly increase the efficacy of the rear skirt panel 122 while increasing the risks that chocks undergone by the RUG 106 damaging the rear skirt panel 122.

The rear skirt panel 122 is further preferably mounted about equal to the side wall 103 of the semi-trailer 100; the rear skirt panel 122 defining a groundward extension of the side wall 103 rearward to the axle(s) 102.

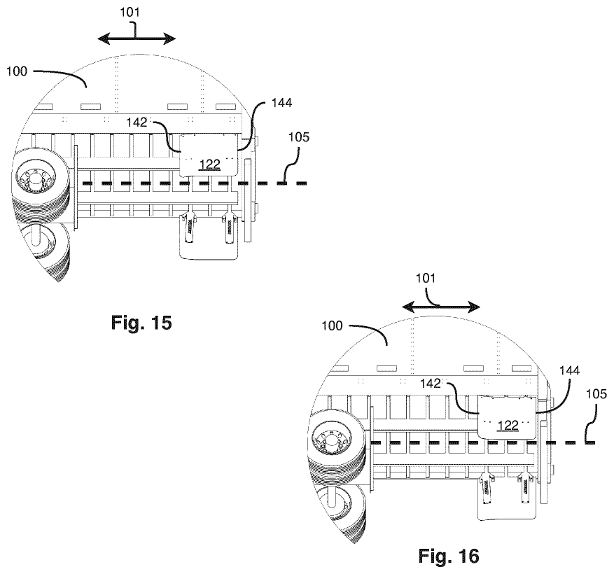

As depicted on FIGS. 13 and 14, according to embodiments, the bottom edge 148 of rear skirt panel 122 is slanted with the front edge 142 of the rear skirt panel 122 extending lower, aka more toward the ground, than its rear edge 144.

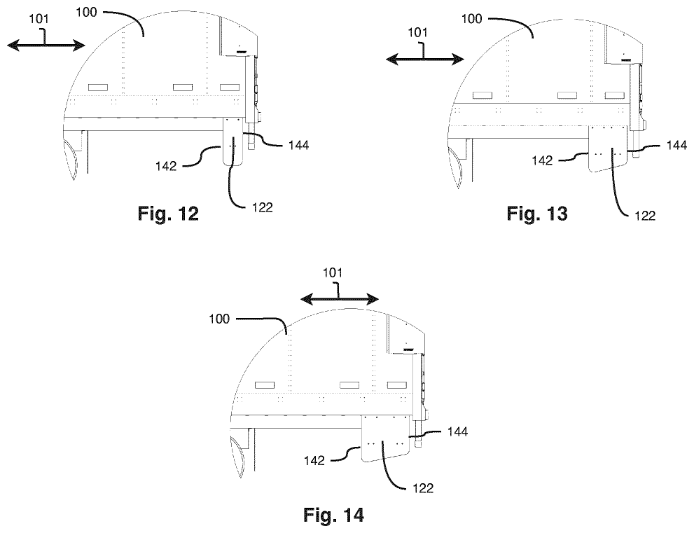

As depicted on FIG. 12, the rear skirt panel 122 may not be tapered with the bottom edge 148 being substantially horizontal FIG. 12 depicts that the rear skirt panel may have a length (in the longitudinal direction of the semi-trailer 100) that may be as low as about one foot (aka about 30 cm) and still provides a drag improvement over the use of front skirt panels 112 alone.

Not depicted, the rear skirt panel 122 may in some embodiments be additionally secured to a linking component mounted to the RUG 106 and to about the bottom edge of the rear skirt panel 122. For instance, the linking component may be a rail structure bearing a carriage component that may freely move longitudinally but that is configured to restrict movements of the bottom edge of the rear skirt panel 122, thus deceasing vibrations the rear skirt panel 122 may undergo while allowing the RUG 106 to be hit without breaking the rear skirt panel 122.

Referring to FIGS. 15-18, the rear skirt panel 122 may feature a curvature (not identified), resulting in a non-flat air-deflection surface. According to embodiment depicted on FIG. 15, the curved portion of the rear skirt panel 122 is substantially frontward from its longitudinal center, with the front edge 142 farther from the centerline 105 of the semi-trailer 100 than the rear edge 144. According to embodiment depicted on FIG. 16, the curved portion of the rear skirt panel 122 is substantially frontward from its longitudinal center, with the front edge 142 closer from the centerline 105 of the semi-trailer 100 than the rear edge 144. According to embodiment depicted on FIG. 17, the curved portion of the rear skirt panel 122 is substantially rearward from its longitudinal center, with the front edge 142 farther from the centerline 105 of the semi-trailer 100 than the rear edge 144. According to embodiment depicted on FIG. 18, the curved portion of the rear skirt panel 122 is substantially rearward from its longitudinal center, with the front edge 142 closer from the centerline 105 of the semi-trailer 100 than the rear edge 144.

Not depicted. According to an embodiment, the rear skirt panel 122 comprises a series of holes for mounting the rear skirt panel 122 to one of the securing mechanisms 124, and a series of horizontally oblong holes for mounting the rear skirt panel 122 to the other one of the securing mechanisms 124. The horizontally oblong holes allow angular adjustment of the rear skirt panel 122 that, when the securing mechanisms 124 are, e.g., clamped to the I-beams 104, result in a greater distance between the securing mechanisms 124. The oblong holes may further be configured to adapt for semi-trailers 100 having different distance between I-beams 104.

It is thereby contemplated therein that the rear aerodynamic skirt assembly may comprise one rear aerodynamic skirt per side of the semi-trailer.

Not depicted, it is also contemplated a rear skirt assembly comprising at least one additional rear aerodynamic skirt per side of the semi-trailer. The additional rear aerodynamic skirt is, for example, mounted front or rear of the first rear aerodynamic skirt; mounted inward to the first rear aerodynamic skirt parallel or at an angle relative to the longitudinal axis smaller than the angle of the first rear aerodynamic skirt relative to the longitudinal axis, wherein the first rear aerodynamic skirt and the additional rear aerodynamic skirt cooperate in defining a bottom-opened channel where highly turbulent airflow resulting from the rotation of the wheels are at least partially limited in its course.

The rear skirt assembly 120 can alternatively contour or be secured to the rear bumper of the semi-trailer 100.

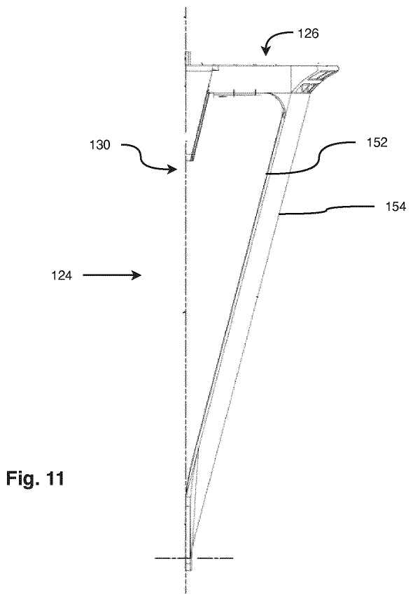

Referring to FIGS. 1 and 11, it is therefore contemplated that according to the embodiments, the securing mechanisms 124 may feature an airfoil shape on the inner face 152 and/or on the outer face 154, the airfoil face participating in decreasing turbulence of the airflow rear to the axle(s) 102.

It is further contemplated that the angle and/or dimension of the airfoil shape may differ between the front securing mechanism 124a and the rear securing mechanism 124b.

It is further contemplated that the airfoil shape is configured generally parallel to the rear skirt panel 122.

Not depicted, it is further contemplated that the width of the securing mechanisms 124 may vary along its height, e.g., being generally greater close to the underfloor than close to the ground.

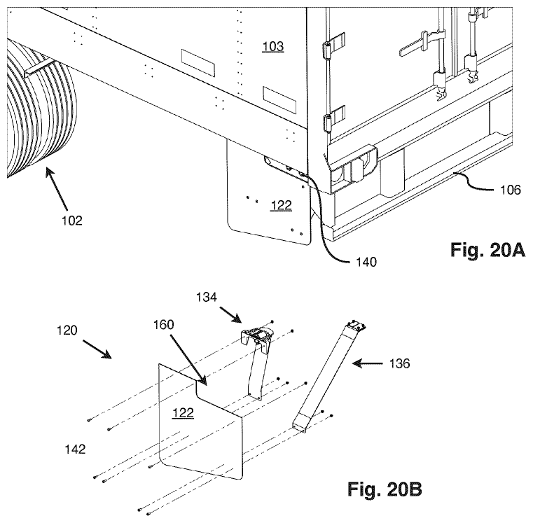

Referring now to e.g., FIGS. 20A and 20B, the rear skirt panel 122 is preferably located rearward to the RUG 106 of the semi-trailer 100. It is worth mentioning that the RUG 106 acts as a bumper and, during the life of the semi-trailer 100, the RUG 106 will be object on numerous shocks that will result in the RUG 106 flexing toward the front.

Accordingly, the rear skirt panel 122 is preferably installed in front of the RUG 106, distant to the RUG 106 of at least four (4) inches, and preferably at least six (6) inches.

Preferably, the rear edge 144 (e.g., see FIG. 5) of the rear skirt panel 122 extends downward to about the bottom limit of the RUG 106 or slightly below the bottom of the RUG 106, limiting thereby the risks of having an obstacle hitting the rear skirt panel 122 when the semi-trailer moves rearward.

Preferably, the front edge 142 (e.g., see FIG. 5) of the rear skirt panel 122 extends downwardly to a height as low as possible according to the applicable laws and to the risks of the rear skirt panel 122 hitting an obstacle. According to a preferred embodiment, the rear skirt panel 122 is chamfered with the rear edge 144 extending downward over about thirty (30) inches relative to the bottom of the I-beams 104 of the semi-trailer 100, while the front edge 142 extending downward over about thirty-six (36) inches relative to the bottom of the I-beams 104 of the semi-trailer 100. This configuration optimize the air-deflection while limiting the risks of the rear skirt panel 122 being crushed by an obstacle.

Furthermore, the rear skirt panel 122 is preferably made of a sheet of resilient material able to vibrate, having its bottom able to move transversally toward and away from the centerline 105 of the semi-trailer 100 as the semi-trailer 100 travels at an exemplary speed of 110-120 km. The sheet is mounted to the semi-trailer 100 about parallel to the side wall 103 of the semi-trailer 100, about equal to the surface of the side wall 103 or slightly inwardly mounted relative to the side wall 103 of the semi-trailer 100.

According to realizations, as depicted e.g., on FIG. 20A, reinforcement structural elements 140 may be present on the semi-trailer 100 to rigidify the RUG 106. In such cases, a portion of the top of the rear skirt panel 122 may be mounted to the reinforcement structural element 140. A clearance 160, e.g., a cut out, may be cut on the rear skirt panel 122 when position of the reinforcement structural element 140 prevents the rear skirt panel 122 to be mounted about flush to the side wall 103.

Referring to the embodiment of FIGS. 20A and 20B, the rear skirt panel 122 is mounted to the semi-trailer 100 with two (2) securing mechanisms 124, preferably a front securing mechanism 134 is designed to resiliently buckle when undergoing an inward lateral force and/or an outward lateral force over a threshold value, allowing the rear skirt panel 122 to flex without breaking, and a rear securing mechanism 136 attaching to the floor of the semi-trailer 100 inward to the reinforcement structural element 140. In a preferred embodiment, the rear skirt panel 122 is therefore mounted with its rear-top portion mounted to the reinforcement structural 140, and its rear-bottom portion mounted to the rear securing mechanism 136. The rear securing mechanism 136 is designed to be able to undergo an inward lateral force with limited flexion while resisting to outward lateral force. In case of shocks, the rear securing mechanism 136 is designed to twist or bend over a certain degree before the rear skirt panel 122 breaking.

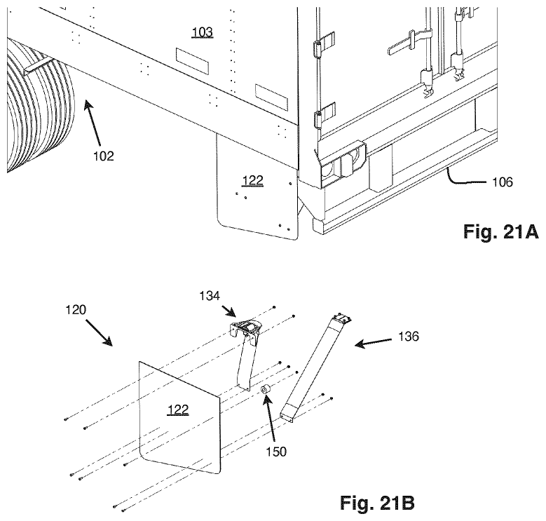

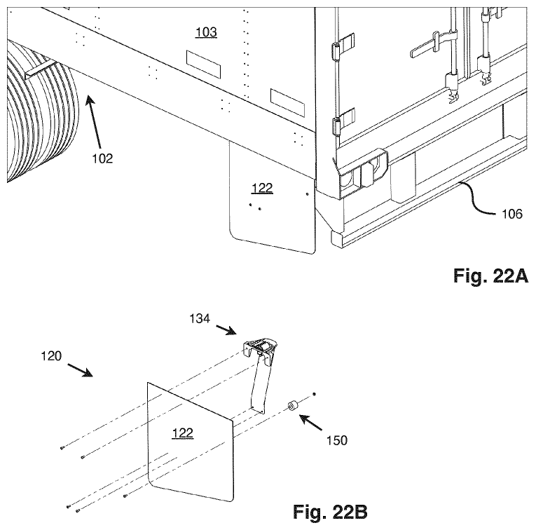

Referring to FIGS. 21A and 22B, the rear skirt panel 122 is designed to be mounted at its top with a deformable mounting component 150, e.g., a rubber-based or alike mounting component allow misalignment without resulting in the rear skirt panel 122 breaking in case the rear skirt panel 122 undergoes external forces. Depicted example involves a rubber bushing through which passed the bolt liking the rear skirt panel 122 to the reinforcement structural element 140.

Referring to FIGS. 22A and 22B, according to an embodiment, the front-top and front-bottom portions of the rear skirt panel 122 are mounted to the front securing mechanism 134 allowing displacement of the bottom of the rear skirt panel 122 without the rear skirt panel 122 breaking, and the rear-top portion is mounted to e.g., the reinforcement structural element 140. The rear-bottom portion remains free of fixation, allowing the rear-bottom portion to flex more than the front portion.

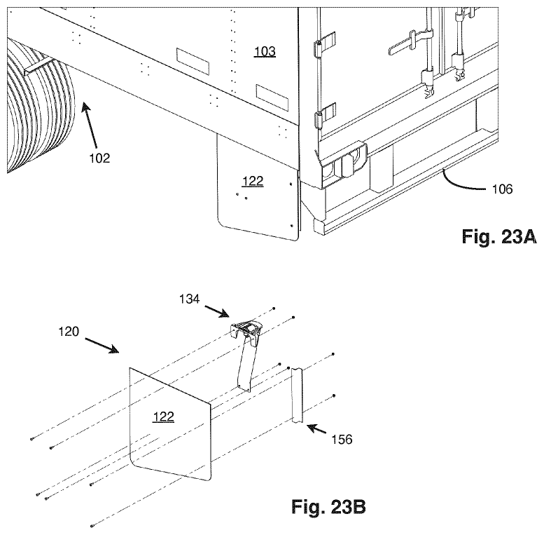

Referring to FIGS. 23A and 23B, the sheet material of the rear skirt panel 122 is thicken about the rear portion extending to the example depicted to its top mounting, or alternatively to its front mounting, increasing locally the rigidity of the rear skirt panel 122 through an additional e.g., layer of deformable material 156.

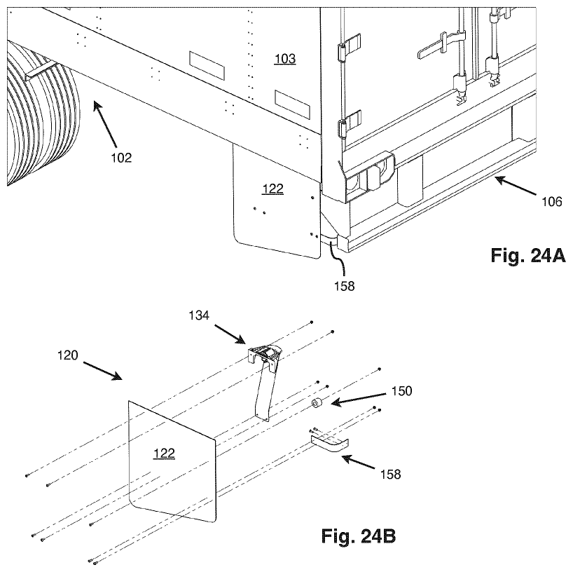

Referring now to FIGS. 24A and 24B, according to an embodiment, the rea-bottom portion of the rear skirt panel 122 may be mounted to the RUG 106. Preferably, the mounting component 158 linking the skirt panel 122 to the RUG 106 is a deformable resilient component resulting in the skirt panel 122 remaining linked to the RUG 106 without breaking if the RUG 106 is deformed, flex frontward.

Therefore, according to preferred embodiments, the rear skirt panel 122 is made of a sheet of resilient material deigned to provide a planar air-deflecting surface when mounted rearward to the rear axle(s) 102, rearward to the rearrest position the bogie 109 (FIG. 1) of the semi-trailer 100 may adopt. The rear skirt panel 122 is designed to be mounted to the semi-trailer 100 about parallel to the centerline 105 with its top and its bottom about the same distance to the centerline 105 of the semi-trailer 100. Preferably, it is mounted about flush to the side wall 103.

The rear skirt panel 122 is preferably designed to be mounted to the semi-trailer 100 with no gap or a minimal gap between the top edge 146 (e.g., see FIG. 5) of the rear skirt panel 122 and the side wall 103 of the semi-trailer 100.

The rear skirt panel 122 is preferably chamfered or shaped otherwise, with its front edge extending lower than its rear edge once mounted to the semi-trailer 100.

The rear skirt panel 122 is preferably mounted to the semi-trailer 100 about its front with a front securing mechanism 134 able to buckle when at least one of an outward force or an inward force is applied to the rear skirt panel 122, with either a bottom portion or a top and a bottom portion of the rear skirt panel 122 being mounted to front securing mechanism 134, leaving the portion above or in-between free to flex if the front securing mechanism 134 buckles.

The rear portion of the rear skirt panel 122 is preferably mounted to the semi-trailer 100 distant from the RUG 106. The rear portion of the 122 may be mounted to the semi-trailer 100 using a securing mechanism 124 similar to the front securing mechanism 134, mounted to the rigid structure using or not resilient mounting components, and optionally using a securing mechanism mounted to the floor of the semi-trailer 100 or to the RUG 106 that can deform if the RUG is pushed without the rear skirt panel 122 breaking.

Accordingly, therethrough is also described a kit for retrofitting a semi-trailer 100 with a rear skirt panel 122 comprising a rear skirt panel 122 as described before, a front securing mechanism 134 as described before, and mounting means to mount the rear portion of the rear skirt panel 122 to the semi-trailer 100.

Accordingly, therethrough is also described method of manufacturing a semi-trailer 100 to comprise a rear skirt panel 122, or retrofitting a semi-trailer 100 to include a rear skirt panel 122. The method comprises mounting a front securing mechanism 134 to a I-beam 104 of the semi-trailer 100 rearward to its bogie 109 but frontward to its RUG 106, securing the front portion of the rear skirt panel 122 to the front securing mechanism 134, and securing the rear portion of the rear skirt panel 122 to the semi-trailer 100 using a deformable mounting means.

While preferred embodiments have been described above and illustrated in the accompanying drawings, it will be evident to those skilled in the art that modifications may be made without departing from this disclosure. Such modifications are considered as possible variants comprised in the scope of the disclosure.

1-20. (canceled)

21. A vehicle comprising an underfloor, a rear axle, and a pair of rear aerodynamic skirt assemblies mounted on each side of the vehicle, each of the rear aerodynamic skirt assemblies comprising:
a skirt panel comprising a mounting face, a planar air-deflecting face opposed to the mounting face, a front edge and a rear edge, wherein the rear edge is shorter than the front edge;
a resilient first securing mechanism, the resilient first securing mechanism being secured to the underfloor of the vehicle, rear to the rear axle, with a low-front portion of the mounting face of the skirt panel mounted thereto, wherein the resilient first securing mechanism is adapted to move between a default position and a flexed position when the resilient first securing mechanism undergoes a first force varying from being zero or under a first threshold value and over the first threshold value; and
a second securing mechanism,
wherein a first section of the skirt panel is mounted to the resilient first securing mechanism and a second section of the skirt panel rearwards to the first section is mounted to the second securing mechanism.

22. The vehicle of claim 21, wherein the first securing mechanism is designed to resiliently buckle when undergoing a center-ward external force over the first threshold value.

23. The vehicle of claim 21, wherein the first securing mechanism is designed to resiliently buckle when undergoing an outward external force over a second threshold value.

24. The vehicle of claim 21, wherein the skirt panel is made of a sheet of material that has a generally uniform thickness.

25. The vehicle of claim 21, wherein a top-front portion of the mounting face of the skirt panel is mounted to the first securing mechanism, with a portion of the skirt panel attachment-free between the low-front portion and the top-front portion.

26. The vehicle of claim 21, further comprising a centerline, wherein the skirt panel has a top edge and a bottom edge, wherein the skirt panel is mounted parallel to the centerline with the top edge and the bottom edge equidistant to the centerline.

27. The vehicle of claim 21, further comprises side walls, and wherein the skirt panel is mounted flush to the side walls.

28. The vehicle of claim 21, further comprising a rear underride guard, wherein the skirt panel is mounted front to the rear underride guard.

29. The vehicle of claim 21, further comprising a rear underride guard, wherein the skirt panel is mounted with the rear edge distant to the rear underride guard.

30. The vehicle of claim 29, wherein the planar air-deflecting face extends in a plane outward to an outer extremity of the rear underride guard.

31. The vehicle of claim 28, wherein the second securing mechanism is secured to the rear underride guard.

32. The vehicle of claim 21, wherein the first securing mechanism and the second securing mechanism are not identical.

33. The vehicle of claim 31, the front edge is designed to extend lower than the rear edge.

34. The vehicle of claim 21, further comprising side walls, wherein each of the skirt panels has a top edge and wherein the top edge of each of the skirt panels adjoins extends parallel and about one of the side walls.

35. The vehicle of claim 21, wherein the planar air-deflecting face extends in a vertical direction from a top edge to a bottom edge without presence of a protrusion, a rift, or a recess in-between.

36. Two rear aerodynamic skirt assemblies configured to be mounted to a vehicle on each side, the vehicle having an underfloor and a rear axle, each of the rear aerodynamic skirt assemblies comprising:
a skirt panel comprising a mounting face, a planar air-deflecting face opposed to the mounting face, a front edge and a rear edge, wherein the rear edge is shorter than the front edge;
a resilient first securing mechanism comprising:
an underfloor mounting means to be secured to the underfloor of the vehicle rear to the rear axle; and
a skirt securing face to mount a low-front portion of the mounting face of the skirt panel thereto;
and
a second securing mechanism,
wherein the resilient first securing mechanism is adapted to move between a default position and a flexed position when the resilient first securing mechanism undergoes a first force varying from being zero or under a first threshold value and over the first threshold value, and
wherein the first resilient securing mechanism and the second securing mechanism are secured independently to the vehicle.

37. The rear aerodynamic skirt assemblies of claim 36, wherein the first securing mechanism is designed to resiliently buckle when undergoing a center-ward external force over the first threshold value.

38. The rear aerodynamic skirt assemblies of claim 36, wherein the first securing mechanism is designed to resiliently buckle when undergoing an outward external force over a second threshold value.

39. The rear aerodynamic skirt assemblies of claim 36, wherein the skirt panel is made of a sheet of material that has a generally uniform thickness.

40. The rear aerodynamic skirt assemblies of claim 36, wherein the first securing mechanism comprises a top sheet securing face to mount a top-front portion of the mounting face of the skirt panel thereto, with a portion of the skirt panel attachment-free between the low-front portion and the top-front portion.
